(19) United States
(12) Patent Application Publication
(10) Pub. No.: US 2006/0041776 A1
(43) Pub. Date: Feb. 23, 2006

(54) Embedded software application

(75) Inventors: Mukul B. Agrawal, Plymouth, MN (US); Lee B. Graba, Minneapolis, MN (US); Vicraj T. Thomas, Golden Valley, MN (US); Saul Cooper, Fridley, MN (US)

Correspondence Address: Honeywell International Inc., Law Dept. AB2, 101 Columbia Road, Morristown, NJ, 07962, US

(73) Assignee: Honeywell International Inc.

(21) Appl. No.: 10/913,119

(22) Filed: Aug. 6, 2004

(51) Int. Cl. G06F 11/00

(52) U.S. Cl. 714/2

(57) ABSTRACT

A system includes a platform on which a plurality of platform-specific I/O and fault-tolerance mechanisms are implemented. The system also includes an embedded software application operating on the platform and middleware which acts as a buffer between the application and the platform. In operation, the middleware logically separates the embedded software application from the platform-specific I/O and fault-tolerance mechanisms, such that the application can be transferred from one platform to another without necessitating complex and time-consuming code changes.

### TECHNICAL FIELD

This application relates in general to high-integrity and high-availability software systems and, more specifically, to software applications embedded in specific hardware systems, such as, for example, avionics control systems.

### BACKGROUND

In many modern devices, the operation of the device is controlled by an advanced control system including one or more embedded software applications. For example, modern aircraft include control systems that closely monitor and control the operation of the aircraft. These control systems typically include numerous sensors and actuators that frequently collect and report data regarding the current status of the aircraft and its surroundings. The systems also include software applications that receive and analyze the data collected by the sensors and actuators, and use this data to make decisions regarding the behavior of the aircraft.

The configuration of an avionics control system can vary significantly from one aircraft to another. For example, many systems include multiple redundant sensors collecting the same data. Such a configuration enables similar data from redundant sensors to be compared to determine whether a sensor has malfunctioned. Also, in the event of a sensor malfunction, the redundant sensors enable the system to continue collecting the necessary information, thereby reducing the possibility of a total system failure. In addition, many control systems implement some form of redundancy at the application level to reduce the possibility of a system failure due to a software error or a malfunction in the underlying platform on which the application operates.

While such redundancies are common in avionics control systems, there can be considerable differences between the particular redundancy schemes adopted by different aircraft manufacturers or even in different aircraft made by the same manufacturer. For example, one aircraft may include two redundant sensors to measure airspeed, whereas another aircraft may include three redundant sensors to measure the same physical property. Further, applications themselves may have redundant copies of a given variable in order to provide fault-tolerance at the application level. In conventional avionics control systems, such differences have a significant impact on the application code because they affect numerous I/O procedures and fault-tolerance strategies embedded in and dispersed throughout the code itself.

As a result, application developers must have a detailed understanding of the intricacies of a specific aircraft and platform configuration before creating the application code for the aircraft. In addition, even minor modifications to an aircraft computing and sensor platform design or configuration can necessitate significant reconfiguration of the corresponding application code. Such reconfiguration, if necessary, can often lead to lengthy delays in obtaining regulatory approval and certification for a given aircraft design.

### SUMMARY OF THE INVENTION

The above-mentioned drawbacks associated with existing embedded software applications are addressed by embodiments of the present invention and will be understood by reading and studying the following specification.

In one embodiment, a system comprises a platform on which a plurality of platform-specific I/O and fault-tolerance mechanisms are implemented. The system further comprises an embedded software application operating on the platform, and middleware interposed between the embedded software application and the platform. The middleware logically separates the embedded software application from the platform-specific I/O and fault-tolerance mechanisms.

In another embodiment, a system includes an embedded software application utilizing application-specific I/O signals. A method of configuring the system comprises calling an initialization procedure and, during the initialization procedure, referencing configuration data regarding the platform on which the embedded software application operates. The method further comprises utilizing the referenced data to instantiate a signal map in which platform-specific I/O signals are correlated with application-specific I/O signals.

In another embodiment, a system comprises a plurality of redundant sensors configured to measure data representing multiple estimates of a given physical property and a plurality of redundant applications representing one or more ways of computing an intermediate value. The system further comprises a transformation module configured to integrate the outputs of the redundant sensors and/or the redundant applications into a uniform signal passed to an embedded software application.

In another embodiment, a method of controlling the operation of a system comprises receiving at least one system input signal in a first format over an input port and transforming the system input signal(s) into at least one application input signal having a second format. The method further comprises creating at least one application output signal in the second format, converting the application output signal(s) into at least one system output signal having the first format, and sending the system output signal(s) over an output port.

In another embodiment, a control system comprises a platform including a backplane, an operating system, and one or more processors. The control system further comprises middleware operating on the platform and an application interacting with the middleware. The middleware receives a plurality of system input signals in a first format and transforms the system input signals into a plurality of application input signals having a second format expected by the application. The middleware also transforms a plurality of application output signals in the second format into a plurality of system output signals having the first format and sends the system output signals over an output port.

The details of one or more embodiments of the claimed invention are set forth in the accompanying drawings and the description below. Other features and advantages will become apparent from the description, the drawings, and the claims.

### BRIEF DESCRIPTION OF THE DRAWINGS

FIG. 1 is a block diagram of one embodiment of an avionics control system having a middleware layer.

FIG. 2 is a diagram illustrating signal I/O mapping for an application operating within a partition.

FIG. 3 is a diagram illustrating the configuration of one embodiment of the middleware.

FIG. 4 is a flow chart illustrating the process for creating the structure of the middleware during partition startup in one embodiment.

FIG. 5 is a diagram illustrating the relationships between the main classes in the middleware.

FIG. 6 is a diagram illustrating one embodiment of a fault-management transform.

Like reference numbers and designations in the various drawings indicate like elements.

### DETAILED DESCRIPTION OF THE PREFERRED EMBODIMENT

In the following detailed description, reference is made to the accompanying drawings that form a part hereof, and in which is shown by way of illustration specific illustrative embodiments in which the invention may be practiced. These embodiments are described in sufficient detail to enable those skilled in the art to practice the invention, and it is to be understood that other embodiments may be utilized and that logical, mechanical, and electrical changes may be made without departing from the spirit and scope of the present invention. The following detailed description is, therefore, not to be taken in a limiting sense.

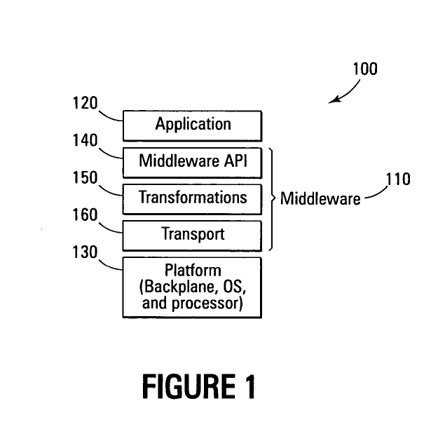

FIG. 1 is a block diagram of one embodiment of an avionics control system node 100 having a middleware layer 110. In the illustrated embodiment, the system node 100 comprises an application 120 operating on a platform 130 comprising a backplane, an operating system, and one or more processors. FIG. 1 shows a single node 100 of a multi-node system communicating through a network or a backplane. In operation, the node 100 typically exchanges data with other nodes 100 in the system. Whereas in conventional avionics control systems the application interacts directly with the underlying platform, in the system illustrated in FIG. 1, the middleware 110 acts as a buffer between the application 120 and the platform 130 on which it operates.

In operation, the middleware 110 exports to the application 120 an application program interface (API) that provides for high-level I/O interaction at the application level. The API also brokers I/O calls from the application 120 to platform-specific interactions. The form of those interactions is preferably determined through configuration of the middleware 110, rather than through compiled code. Thus, changes in the platform 130 on which the application 120 operates or even in the aircraft associated with the application 120 (assuming the same requirements between aircraft) can advantageously be handled through configuration of the middleware 110, rather than through complex and time-consuming re-coding of the application 120. In a preferred embodiment, the middleware 110 is sufficiently parameterized such that the expected types of variations across platforms 130 and aircraft can be handled through configuration.

In the illustrated embodiment, the middleware 110 comprises an API layer 140, a transformation layer 150, and a transport layer 160. The API layer 140 is exposed to the applications 120. In some embodiments, the API layer 140 comprises three elements. The first element is a set of classes that define a small set of signal types, each representing a different type of value, referred to as application signals. In operation, applications 120 refer to the definitions stored in the first element of the API layer 140 to create instances of the defined signal types corresponding to the inputs and outputs with which the applications 120 need to interact. An application 120 can also query the signals about their characteristics, such as their current validity, freshness, update rate, expected latency, allowable range, and for floating point types, resolution and precision.

The second element of the API layer 140 comprises two classes that are used to group together application signals that should be refreshed or written all at the same time. In one particular exemplary embodiment, these classes are referred to as InputSignalGroup and OutputSignalGroup. To provide an example, if an application 120 has a 10 Hz periodic task, with a number of input signals used by that task, including redundant input signals, the application 120 would create the appropriate signals, create an InputSignalGroup, associate the signals with the group, and register the group with the middleware 110, as discussed in more detail below. Then, on every cycle, the refresh method would be called on the InputSignalGroup, causing the middleware 110 to refresh the appropriate signals to be updated with current values. A similar arrangement could be used with output signals, except that an OutputSignalGroup would be used, and the write method would be used to send the current values of the associated output signals out into the platform 130.

The third element of the API layer 140 comprises two registration functions that are used to register an Input/OutputSignalGroup with the middleware 110. In one particular exemplary embodiment, these functions are referred to as registerInputSignalGroup and registerOutputSignalGroup. In operation, these registration functions enable the middleware 110 to set up the data paths between the signals created by the application 120 and the system signals that exist at the platform layer.

In a preferred embodiment, the API layer 140 of the middleware 110 is sufficiently rich that applications 120 can be written to interact only with the API layer 140. As a result, applications 120 can specify I/O data without platform-specific information, such as addresses, board type, board number, etc., and need not be written to be platform- and aircraft-specific. Rather, a standard application 120 can be moved from one aircraft to another, without necessitating changes to the I/O interaction code of the application 120.

In the embodiment illustrated in FIG. 1, the second layer of the middleware 110 is the transformation layer 150. In operation, this layer converts signals generated at the application level to signals that are meaningful at the platform level and vice versa. In general, application-level signals referred to as “application signals,” and platform-level signals are referred to as “system signals.” Although there is typically some relationship or correspondence between application signals and system signals, the particular characteristics of the application signals are often different from those of the system signals. This is especially likely if the application 120 is ported from one aircraft to another in which similar signals are defined differently.

To provide one example, a signal for airspeed may be defined in units of knots in one aircraft, but in units of meters/second in another aircraft. In a conventional avionics control system, a set of code changes would be required to transfer an application developed for the first aircraft to the second to account for the difference in units. In the system illustrated in FIG. 1, however, the transformation layer 150 of the middleware 110 can be used to transform system signals into the forms that are expected by the application 120, and vice versa. In this particular example, i.e., a units mismatch, a scaling transformation can be used to convert the airspeed system signal into whatever units are expected by the application 120, thereby advantageously eliminating the need for a set of code changes in the application 120.

In a preferred embodiment, a number of standard transformations are constructed in advance. These standard transformations are preferably parameterized, meaning that their characteristics can be determined by parameters read at startup time from configuration data. Such an arrangement greatly reduces the number of code changes that must be performed to transfer an application 120 from one aircraft or platform 130 to another, although as a practical matter, it is likely that the need for such code changes cannot be eliminated entirely.

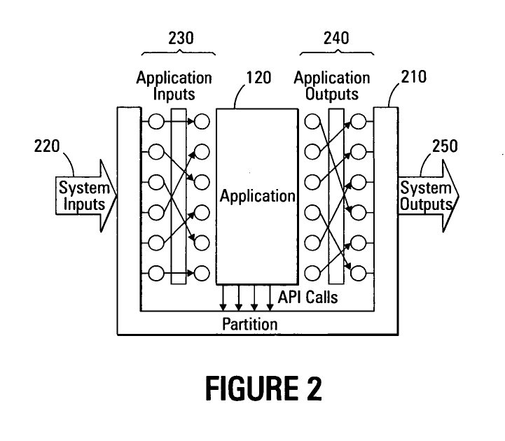

In addition to addressing mismatches in signal format, the transformation layer 150 also addresses the correlation and matching of system signals and application signals. For example, a first aircraft or platform 130 may assign a first ID to a given system signal, e.g., airspeed, whereas a second aircraft or platform 130 may assign a different ID to the same system signal. The transformation layer 150 of the middleware 110 can be used to map the appropriate system signals onto the corresponding application signals, and vice versa, as illustrated in FIG. 2.

In the illustrated embodiment, the application operates within a discrete partition 210, as set forth in the ARINC 653 specification, which is described in more detail below. In operation, the transformation layer 150 of the middleware 110 matches the system input signals 220 received at the partition boundary with their equivalent application input signals 230. The transformation layer 150 also matches the application output signals 240 with their equivalent system output signals 250 to be transferred beyond the partition 210 over an ARINC 653 channel. The characteristics of the mapping function performed by the transformation layer 150 are preferably determined by parameters read at startup time from configuration data. As a result, code changes are not required to account for differences between IDs assigned to the same system signals by different aircraft or platforms 130.

Similar techniques can be used to account for differences in the redundancy schemes implemented on different aircraft or platforms 130. For example, one aircraft may include two redundant sensors to measure airspeed, whereas another aircraft may include three redundant sensors to collect the same data. In either case, the accepted airspeed signal value can be determined using any of a wide variety of well-known “sensor voting” algorithms. Once such a determination is made, the aircraft may include multiple exact replicas of the accepted airspeed signal value in redundant programs executing on identical computers in accordance with a variety of software redundancy schemes.

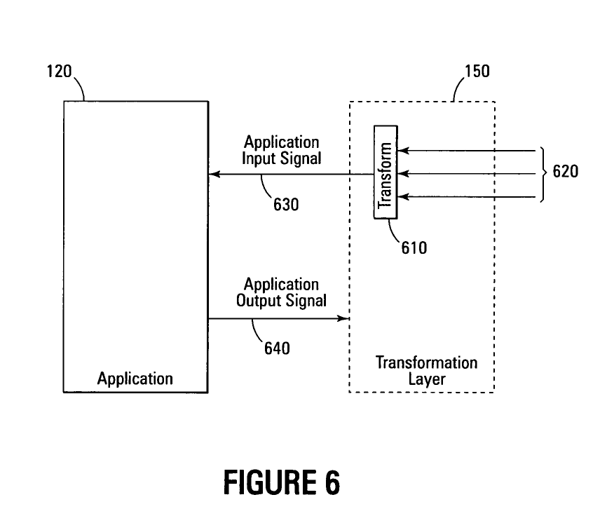

In some embodiments, these redundancy schemes are implemented in a series of “fault-management” transforms, one example of which is illustrated in FIG. 6. In the illustrated embodiment, the transform 610 comprises one element of the transformation layer 150 of the middleware 110. In operation, the transform 610 accepts a plurality of redundant input signals 620 and produces a single transformed signal 630 that is in turn used by the application 120 to generate one or more output signals 640. In some embodiments, a fault-management transform 610 is defined for a specific aircraft platform and is independent of the actual sensors being used. To provide one example, one transform 610 may choose the first valid input from a plurality of sensors, whereas another transform 610 may choose the median value of all valid inputs.

The details of the particular hardware and software redundancy schemes implemented on a given platform 130 are ultimately irrelevant to the applications 120 operating on the platform 130. For example, an application 120 referencing airspeed typically does not need to know how many sensors gather airspeed data or how an airspeed signal value is determined; rather, the application 120 simply needs to know the accepted value of the airspeed signal. Thus, in a preferred embodiment, the transformation layer 150 of the middleware 110 combines all of the signals or inputs that relate to a single physical or computed property into one “redundant signal group,” and passes the accepted signal value to requesting applications 120 in the proper form. Applications 120 preferably do not distinguish between inputs from sensors and inputs from other applications 120.

Moreover, in some embodiments, a platform 130 includes a plurality of redundant applications 120 representing multiple ways of computing a given intermediate value. The transformation layer 150 of the middleware 110 can integrate the outputs of the redundant applications 120 into a uniform output signal passed to other (possibly redundant) applications 120. The redundant applications 120 need not be aware of the existence of their replicas.

The transformation layer 150 of the middleware 110 enables applications 120 to receive input signals and generate output signals in the form they expect, while the details of the particular hardware and software redundancy schemes implemented on the underlying platform 130 remain transparent. Accordingly, the transformation layer 150 advantageously enables a degree of separation between the development of an application 120 and the development of the overall system, and enables the application 120 to be relatively independent of the fault-tolerance and I/O details of the overall control system.

Referring again to FIG. 1, the third layer of the middleware 110 is the transport layer 160, which interacts with the platform 130 and with the transformation layer 150. In operation, the transport layer 160 acquires input system signals from the platform 130 and delivers these signals to the transformation layer 150. The transport layer 160 also receives output system signals from the transformation layer 150 and delivers these signals to the platform 130.

In some embodiments, the system operates in accordance with the ARINC 653 specification. As will be understood by those of ordinary skill in the art, this specification sets forth standards for a time and space partitioning operating system in which applications 120 are separated into discrete partitions on a single processor. Each partition is guaranteed a slice of time for execution as specified by the system designer.

The specification provides for the transfer of data between partitions over 653 channels through which arrays of bytes can be transferred. There are no industry-wide standards, however, for the format of the data passed over ARINC 653 channels. As a result, the format of the data may vary from aircraft to aircraft. Accordingly, the definitions for data packets transmitted over the ARINC 653 channels are implemented in the transport layer 160 of the middleware 110. This configuration advantageously enables signal data to be transferred efficiently across a channel by including several related signals in the same packet and sending only that type of data across the channel.

To provide an example, a navigation application 120 might produce three position signals (e.g., latitude, longitude, and altitude) at a rate of 10 Hz. The transport layer 160 for this application 120 would pack all three signal values into a single packet, and send them over a given channel at 10 Hz. Applications 120 that need to use any or all of those signals would be consumers of that channel, and pull the necessary signals out of the packet, as defined by the navigation application 120. The details related to the packet definition would preferably be determined by parameters read at startup time from configuration data.

In some embodiments, this approach is implemented by constructing a set of system signal classes representing the same data types as the application signal classes. These classes have the capability to serialize their values and attributes (e.g., ID, type, size, CRC) into a byte array, as well as to update their values from a byte array. Two classes are constructed to interact with the channel, as well as hold the specification of the ID, type, and order of signals included in each packet. In one particular exemplary embodiment, these classes are referred to as SignalListReader and SignalListWriter.

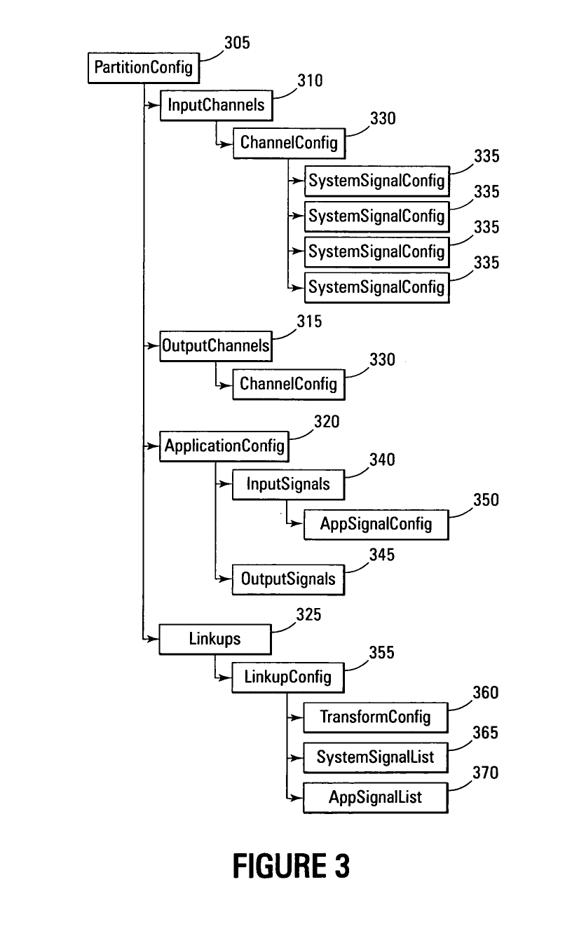

FIG. 3 is a diagram illustrating the configuration of one embodiment of the middleware 110. In the figure, arrows denote containment. For example, in the illustrated embodiment, the middleware 110 comprises a PartitionConfig class 305, which contains an InputChannels list 310, an OutputChannels list 315, an ApplicationConfig object 320, and a Linkupslist 325. The InputChannels list 310 and the OutputChannels list 315, in turn, contain a number of ChannelConfig objects 330, each of which contains a plurality of SystemSignalConfig objects 335.

The PartitionConfig class 305 contains all the configuration information needed by the partition 210 to startup. Specifically, the lists of input and output channels, along with configuration information about those channels, enable the middleware 110 to create the input and output ports for those channels. In addition, each ChannelConfig object 330 contains a list of SystemSignalConfig objects 335, which provide the information about the signal data that will be transferred over the channels. This configuration provides the middleware 110 with all of the information needed to send a list of signals over a channel, and to read a list of signals from the channel.

In the illustrated embodiment, the ApplicationConfig object 320 contains an InputSignals list 340 and an OutputSignals list 345. The InputSignals list 340, in turn, contains an AppSignalConfig object 350. This configuration provides the ApplicationConfig object 320 with all of the information necessary to create and start the application 120.

In addition, in the illustrated embodiment, the Linkups list 325 contains LinkupConfig objects 355, each of which contains a TransformConfig object 360, a SystemSignalList 365, and an AppSignalList 370. This information is used to map between the system signals 220, 250 read into or written out of the partition 210, and the application signals 230, 240. The information is also used to create the transformations needed to perform the mapping functions.

In some embodiments, the system signals and application signals are defined in abstract base classes holding a number of common attributes, such as the signal ID (which is unique across the system), the type of the object, and the validity and freshness of the signal. The system signal abstract base class also preferably has the ability to convert its ID, type, value and a CRC value into a byte array, and to update these attributes from a byte array.

Transformation classes, which are also abstract base types, provide a link between the system signals and the application signals. In some embodiments, the middleware 110 comprises three transformation classes, which are referred to as InboundTransform, OutboundTransform, and RedirectTransform. In these embodiments, an InboundTransform converts an incoming system signal into an application input signal, an OutboundTransform converts an outbound application signal into a system signal, and a RedirectTransform routes an application output signal back into the application 120 as an input signal. As discussed above, in a preferred embodiment, there are a number of standard transformations that would be chosen at configuration time, which do not need to be re-coded and re-compiled. For example, a general polynomial transform, with both input range limits and output range limits, and a polynomial transformation may be able to handle a large percentage of transformations between like (e.g., float-to-float, double-to-double, etc.) signals.

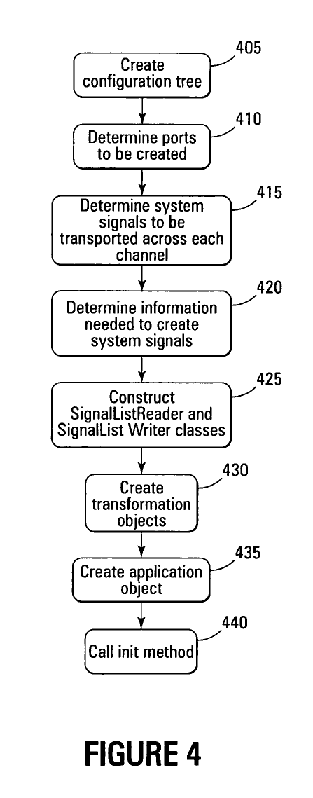

FIG. 4 is a flow chart illustrating the process for creating the structure of the middleware 110 during partition startup in one embodiment. In a first step 405, a configuration tree representing the configuration of the partition 210 is created. In a next step 410, a determination is made as to which ARINC 653 ports need to be created. Then, in a step 415, the system signals to be transported across each channel are identified. In a step 420, the information needed to create the system signals is determined. In a next step 425, the SignalListReader and SignalListWriter classes are constructed with the appropriate ports and signals. In some embodiments, each SignalListReader is assigned to one port, and is able to pull packets out of the port and use the packets to refresh the values of the corresponding signals. Similarly, each SignalListWriter is assigned to one port, and is able to write the values for its list of system signals into a byte array, which is sent over the output port.

In a step 430, the transformation objects are created. As discussed above, these objects provide a link between the system signals and the application signals. In a next step 435, the application object is created, and in a final step 440, an init method is called. The init method creates the appropriate application signals, associates them with InputSignalGroups and OutputSignalGroups, and registers these groups. During the registration process, the application signals are matched up to the corresponding transformation objects by referencing the signal names and information stored in the LinkupConfig object loaded by the partition 210. As a result, the application signals are implicitly matched up to the equivalent system signals, and each application signal is associated with the appropriate SignalListReader or SignalListWriter.

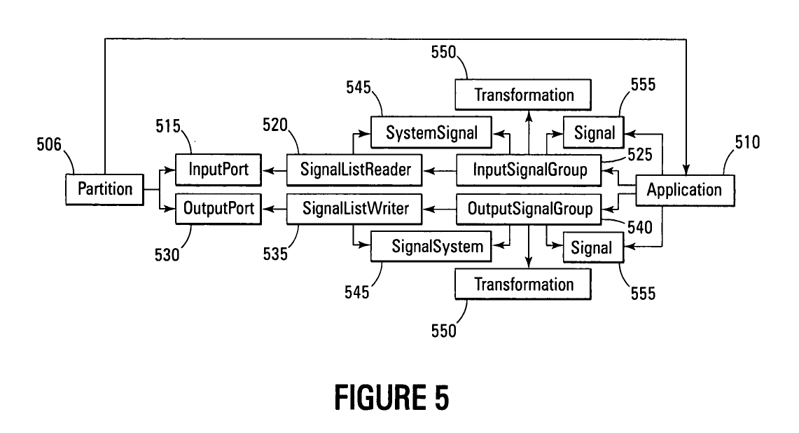

FIG. 5 is a diagram illustrating the relationships between the main classes in the middleware 110 following the construction process illustrated in FIG. 4. In the illustrated embodiment, the middleware 110 comprises a Partition 505 object in communication with an Application 510 object through a series of InputPort 515, SignalListReader 520, and InputSignalGroup 525 objects, as well as through a series of OutputPort 530, SignalListWriter 535, and OutputSignalGroup 540 objects. Both the InputSignalGroup 525 and the OutputSignalGroup objects 540 are in communication with a number of SystemSignal 545, Transformation 550, and Signal 555 objects. The Signal 555 objects are also in communication with the Application 510 object. Similarly, the SystemSignal 545 objects are in communication with the SignalListReader 520 and SignalListWriter 535 objects, respectively.

In operation, on each cycle, the Application 510 calls the refresh method on its associated InputSignalGroups 525. The InputSignalGroups 525, in turn, call the refresh methods on their associated SignalListReaders 520, which causes the SignalListReaders 520 to read their InputPorts 515, extract data packets, and use the packets to refresh the system signals. Each Transformation 550 then calls a doTransform method to process any conversions between system signals and application signals, if necessary. Once this process is complete, the values of the application signals are updated into the appropriate form expected by the Application 510. The Application 510 then uses a getvalue method to get the current value of each signal.

With respect to outbound signals, the Application 510 calls the setValue methods of its associated output signals, and then calls the write method of the corresponding OutputSignalGroups 540. The OutputSignalGroups 540 execute the Transformations 550 necessary to convert application signal outputs into system signal outputs. The appropriate SignalListWriters 535 are then called to convert the system signals into byte arrays to be sent out over the OutputPorts 530 in accordance with the ARINC 653 specification.

The systems and methods described above present a number of distinct advantages over conventional embedded software applications. For example, using the systems and methods described above, common I/O operations and fault-tolerance strategies can be abstracted out, meaning that duplicate, dissimilar, platform-specific mechanisms for I/O interaction and fault-tolerance can be pulled out of the application code and placed into the common middleware layer. This abstraction advantageously reduces the amount of code that is duplicated (in sometimes inconsistent ways) across applications and standardizes I/O and fault-tolerance interaction techniques across applications.

This approach also advantageously enhances the portability of applications across platforms and insulates applications from changes in a given platform. As a result, applications can be transferred more efficiently between different aircraft, or between different models of the same aircraft having different sensors, actuators, or redundancy schemes. In addition, aircraft designers can be given greater flexibility when contemplating changes in the platform configuration of a given aircraft.

The systems and methods described above also advantageously insulate application developers from the I/O and fault-tolerance complexities of the underlying platforms on which their applications operate. As a result, application developers do not have to be concerned with the specifics of where signals originate and how they are transported through the system. Rather than incorporating complex, platform-dependent I/O and fault-tolerance operations into their applications, developers can expect that incoming signals will be delivered in the proper form to their application boundary, and that output signals will be delivered from their application to the appropriate destinations.

Moreover, while the foregoing description refers primarily to an avionics control system as one exemplary embodiment, the systems and methods described herein can be applied to a wide variety of other devices having embedded software applications. For example, these systems and methods can be implemented in applications embedded within other mobile vehicles (e.g., tanks, automobiles, ships, space vehicles), medical devices (e.g., MRI and X-Ray machines), industrial control applications (e.g., oil and gas refining, paper and pulp, pharmaceuticals, chemicals), power-transmission, and high-availability enterprise applications (e.g., financial systems).

Although this invention has been described in terms of certain preferred embodiments, other embodiments that are apparent to those of ordinary skill in the art, including embodiments that do not provide all of the features and advantages set forth herein, are also within the scope of this invention. Accordingly, the scope of the present invention is defined only by reference to the appended claims and equivalents thereof.

What is claimed is:

1. A system comprising:
a platform on which a plurality of platform-specific I/O and fault-tolerance mechanisms are implemented;
an embedded software application operating on the platform; and
middleware interposed between the embedded software application and the platform,
wherein the middleware logically separates the embedded software application from the platform-specific I/O and fault-tolerance mechanisms.

2. The system of claim 1, wherein the system comprises an avionics control system.

3. The system of claim 1, wherein the platform comprises a backplane, an operating system, and one or more processors.

4. The system of claim 1, wherein the middleware comprises an API layer, a transformation layer, and a transport layer.

5. The system of claim 4, wherein the API layer is configured to interact directly with the embedded software application, such that the embedded software application does not need to interact directly with the platform.

6. The system of claim 4, wherein the transport layer is configured to acquire input system signals from the platform and deliver the input system signals to the transformation layer.

7. The system of claim 4, wherein the transport layer is configured to receive output system signals from the transformation layer and deliver the output system signals to the platform.

8. The system of claim 4, wherein the transport layer is configured to include multiple related signals in a single data packet.

9. The system of claim 1, wherein the middleware comprises a plurality of standard parameterized transformations.

10. The system of claim 1, wherein the middleware is configured to correct mismatches in signal format between platform-specific signals and application-specific signals.

11. The system of claim 1, wherein the middleware is configured to correlate and match platform-specific signals with corresponding application-specific signals.

12. The system of claim 1, wherein the middleware is configured to combine multiple signals or inputs related to a single physical property or computed value into a redundant signal group.

13. The system of claim 1, wherein the operation of the middleware is controlled by configuration data referenced at the startup of the system.

14. The system of claim 1, wherein the embedded software application operates in accordance with the ARINC 653 specification.

15. A method of configuring a system having an embedded software application utilizing application-specific I/O signals, the method comprising:
calling an initialization procedure;
during the initialization procedure, referencing configuration data regarding the platform on which the embedded software application operates; and
utilizing the referenced data to instantiate a signal map in which platform-specific I/O signals are correlated with application-specific I/O signals.

16. The method of claim 15, wherein the configuration of I/O code and transformation code is performed independently of the configuration of the embedded software application.

17. The method of claim 15, wherein the system comprises an avionics control system.

18. The method of claim 15, wherein the platform comprises a backplane, an operating system, and one or more processors.

19. The method of claim 15, wherein the system comprises middleware including an API layer, a transformation layer, and a transport layer.

20. The method of claim 19, wherein the API layer is configured to interact directly with the embedded software application, such that the embedded software application does not need to interact directly with the platform.

21. The method of claim 19, wherein the transport layer is configured to acquire input system signals from the platform and deliver the input system signals to the transformation layer.

22. The method of claim 19, wherein the transport layer is configured to receive output system signals from the transformation layer and deliver the output system signals to the platform.

23. The method of claim 19, wherein the transport layer is configured to include multiple related signals in a single data packet.

24. The method of claim 19, wherein the middleware comprises a plurality of standard parameterized transformations.

25. The method of claim 19, wherein the middleware is configured to correct mismatches in signal format between platform-specific signals and application-specific signals.

26. The method of claim 19, wherein the middleware is configured to combine multiple signals or inputs related to a single physical property or computed value into a redundant signal group.

27. The method of claim 15, wherein the embedded software application operates in accordance with the ARINC 653 specification.

28. A system comprising:
a plurality of redundant sensors configured to measure data representing multiple estimates of a given physical property;
a plurality of redundant applications representing one or more ways of computing an intermediate value;
a transformation module configured to integrate the outputs of the redundant sensors and/or the redundant applications into a uniform signal passed to an embedded software application.

29. The system of claim 28, wherein the system comprises an avionics control system.

30. The system of claim 28, wherein the transformation module comprises a plurality of standard parameterized transformations.

31. The system of claim 28, wherein the transformation module is configured to correct mismatches in signal format between system signals and application signals.

32. The system of claim 28, wherein the operation of the transformation module is controlled by configuration data referenced at the startup of the system.

33. The system of claim 28, wherein the embedded software application operates in accordance with the ARINC 653 specification.

34. A method of controlling the operation of a system comprising:
receiving at least one system input signal in a first format over an input port;
transforming the system input signal(s) into at least one application input signal having a second format;
creating at least one application output signal in the second format;
converting the application output signal(s) into at least one system output signal having the first format; and
sending the system output signal(s) over an output port.

35. The method of claim 34, wherein the system comprises an avionics control system.

36. The method of claim 34, wherein the system comprises a platform having a backplane, an operating system, and one or more processors.

37. The method of claim 34, wherein the system comprises middleware having a plurality of standard parameterized transformations.

38. The method of claim 37, wherein the middleware is configured to correlate and match platform-specific signals with corresponding application-specific signals.

39. The method of claim 37, wherein the middleware is configured to combine multiple signals or inputs related to a single physical property or computed value into a redundant signal group.

40. The method of claim 37, wherein the operation of the middleware is controlled by configuration data referenced at the startup of the system.

41. A control system comprising:
a platform including a backplane, an operating system, and one or more processors;
middleware operating on the platform; and
an application interacting with the middleware,
wherein the middleware receives a plurality of system input signals in a first format and transforms the system input signals into a plurality of application input signals having a second format expected by the application, and
wherein the middleware transforms a plurality of application output signals in the second format into a plurality of system output signals having the first format and sends the system output signals over an output port.

42. The control system of claim 41, wherein the control system comprises an avionics control system.

43. The control system of claim 41, wherein the middleware comprises an API layer, a transformation layer, and a transport layer.

44. The control system of claim 43, wherein the API layer is configured to interact directly with the application, such that the application does not need to interact directly with the platform.

45. The control system of claim 43, wherein the transport layer is configured to acquire input system signals from the platform and deliver the input system signals to the transformation layer.

46. The control system of claim 43, wherein the transport layer is configured to receive output system signals from the transformation layer and deliver the output system signals to the platform.

47. The control system of claim 43, wherein the transport layer is configured to include multiple related signals in a single data packet.

48. The control system of claim 41, wherein the middleware comprises a plurality of standard parameterized transformations.

49. The control system of claim 41, wherein the middleware is configured to correct mismatches in signal format between platform-specific signals and application-specific signals.

50. The control system of claim 41, wherein the middleware is configured to correlate and match platform-specific signals with corresponding application-specific signals.

51. The control system of claim 41, wherein the middleware is configured to combine multiple signals or inputs related to a single physical property or computed value into a redundant signal group.

52. The control system of claim 41, wherein the operation of the middleware is controlled by configuration data referenced at the startup of the control system.

53. The control system of claim 41, wherein the application operates in accordance with the ARINC 653 specification.
